(19) United States
(12) Patent Application Publication
(10) Pub. No.: US 2025/0100645 A1
(43) Pub. Date: Mar. 27, 2025

(54) FOLDABLE BICYCLE

(71) Applicant: Better Bicycles Limited, Bristol (GB)

(72) Inventor: Jody Muelaner, Bristol (GB)

(21) Appl. No.: 18/728,873

(22) PCT Filed: Jan. 13, 2023
(86) PCT No.: PCT/GB2023/050059

§ 371 Date: Jul. 13, 2024

(30) Foreign Application Priority Data
Jan. 14, 2022 (GB) 2200472.5

(51) Int. Cl. B62K 15/00; B62K 3/02

(52) U.S. Cl. CPC B62K 15/006; B62K 3/02; B62K 2015/005

(57) ABSTRACT

A bicycle includes a frame having four bar elements, wherein the first bar element is pivotally connected to the second bar element by a first hinge, the second bar element is pivotally connected to the third bar element by a second hinge, the third bar element is pivotally connected to the fourth bar element by a third hinge and the fourth bar element is pivotally connected to the first bar element by a fourth hinge, a front axle protruding from the third bar element for mounting a front wheel, a rear axle protruding from the first bar element for mounting a rear wheel, wherein the fourth hinge is disposed rear of the rear axle, at least one handlebar attached to the third bar element.

The present invention relates to a foldable bicycle.

### BACKGROUND TO THE INVENTION

Bicycles can be bulky, and as a result can be difficult to store when not in use. They can also be cumbersome to transport when not being ridden, for example, on a railway platform or in a corridor.

Foldable bicycles are known. A foldable bicycle is configurable between a folded and an unfolded state. In the folded state, they typically occupy less space. Foldable bicycles are typically foldable by nature of hinged portions in their frame.

Various designs of foldable bicycles comprising hinged portions in their frame have been proposed.

One example of a known bicycle, “Strida”, comprises a triangular frame that must be broken. The three bars may then be folded together. In this design the front and rear wheels are disposed adjacent to each other, side-by-side, when the bicycle is folded.

CN201670320 discloses a foldable bicycle with a four-bar linkage. In this design, a first hinge is disposed on an upper frame piece, and a further three disposed on a lower frame piece. One hinge is positioned behind the front wheel, one in the centre of the lower piece, and one in front of the rear wheel. To fold, the centre of the lower frame rises, bringing the front and rear wheels closer together with the front wheel remaining in front of the back wheel, until they are adjacent, one wheel directly in front of the other, in the fully-folded position.

Another example, the “Sinclair A-Bike” has a frame in the form of a five-bar linkage. This design is similar in structure and folds in a similar way to the bicycle disclosed in CN201670320, but with an additional bar element in the lower frame piece. In this design the wheels are again disposed one in front of the other, but brought close together in the folded state.

These bicycles are folded primarily for storage purposes, for example to be stored in a cupboard or on a luggage rack in a train. Some prior art folding bicycles can be rolled on their wheels while folded, by pushing the folded bicycle in front of the operator.

However, when in the folded state, steering these bicycles may difficult due to a lack of stability. Furthermore, steering may place stress on the operator's arm when pushing the folded bicycle for a long distance.

Additionally, it may be difficult or time-consuming to fold these bicycles, particularly if the frame of the foldable bicycle needs to be broken. Space may be required to manipulate the state of a foldable bicycle, and as a result, folding the bicycle may be particularly difficult in a crowded or confined area, for example on a train or a railway platform.

It is an object of the present invention to reduce or substantially obviate the aforementioned problems.

### STATEMENT OF INVENTION

According to the present invention there is provided a foldable bicycle comprising:
a frame comprising;
   a first bar element;
   a second bar element;
   a third bar element;
   a fourth bar element,
   wherein the first bar element is pivotally connected to the second bar element by a first hinge, the second bar element is pivotally connected to the third bar element by a second hinge, the third bar element is pivotally connected to the fourth bar element by a third hinge and the fourth bar element is pivotally connected to the first bar element by a fourth hinge;
   a front axle protruding from the third bar element for mounting a front wheel;
   a rear axle protruding from the first bar element for mounting a rear wheel, wherein the fourth hinge is disposed rear of the rear axle;
   at least one handlebar attached to the third bar element;
   at least one crank arm for mounting pedals, disposed on the first bar element;
   in which the foldable bicycle is configurable between a folded and unfolded configuration, wherein the first hinge is raisable towards the fourth bar element, bringing the front and rear wheel closer together.

The four bar elements allow the frame to be folded from an unfolded configuration into a folded configuration.

In the unfolded configuration, the first bar element may correspond to a chain stay portion of a traditional bicycle frame. The second bar element may correspond to a down tube portion of a traditional bicycle frame. The third bar element may form a steering column. The third bar element may provide a single prong of a traditional bicycle fork. Part of the fourth bar element may roughly correspond to a top tube portion of a traditional bicycle frame. Part of the fourth bar element may roughly correspond to a seat stay portion of a traditional bicycle frame.

Preferably, the axes on which the first, second, third and fourth hinges pivot to fold the bicycle are substantially parallel with each other, and also parallel with the axes on which the front and rear wheels rotate (the front wheel axis is of course movable to steer the bicycle, but is parallel with the rear wheel axis, and the axes of the hinges, when the bicycle is being ridden in a straight line).

In the folded configuration, the bicycle may have a tall and narrow shape. The folded configuration may occupy less space than the unfolded configuration.

It has been found that when the fourth hinge is disposed rear of the rear axle, the weight of the bicycle assists in retracting the rear wheel into the frame during reconfiguration from the unfolded configuration to the folded configuration.

At least one castor wheel may protrude from at least one bar element, wherein the castor wheel is rotatable about a castor wheel axis which is perpendicular to the front and rear wheel axis;

In the folded configuration, the front and rear wheels may move upwards relative to the at least one castor wheel when the front and rear wheel are brought together.

In the folded configuration, the at least one castor wheel is positioned below the front and rear wheels, the front and rear wheels are clear of ground and the castor wheel is in contact with the ground. The at least one castor wheel may provide a means for pushing or pulling the bicycle in its folded configuration.

It will be appreciated that while a four-bar linkage is described, the invention may include additional bar elements to serve the same purpose.

The front axle may protrude from a bottom end of the third bar element.

One or both of the front and rear axles may protrude from the frame on one side only of a plane substantially bisecting the frame. As a result, the front and rear wheels are mounted to the front and rear axles on one side of the frame only and the wheels do not need to be removed to change a tyre.

The front and rear axles may protrude from different sides of the plane substantially bisecting the bicycle. This may allow the rear wheel to be disposed on one side of the frame and the front wheel disposed on the other side of the frame. In this orientation the wheels may retract adjacent to each other, side-by-side, and thereby occupy less space in the folded configuration.

The front wheel may have a diameter of 20 to 50 cm.

The rear wheel may have a diameter of 20 to 50 cm.

The bicycle may comprise at least one locking mechanism for locking the frame in the folded and/or unfolded configuration.

The locking mechanism may comprise an over-centre lever The over-centre lever may have an operating handle. The operating handle allows the over-centre lever to lock and/or unlock to facilitate reconfiguration from the folded configuration to the unfolded configuration and vice versa.

The operating handle may be disposed protruding from or adjacent to the fourth bar member. This mitigates the risk that the operating handle is accidentally lifted by movement of the operator's body whilst the bicycle is being ridden in the unfolded configuration.

A castor wheel may be connected to the fourth bar element. The castor wheel may be connected to a rear end of the fourth bar element.

A castor wheel bar may protrude from the third bar element. The castor wheel bar may protrude from a bottom end of the third bar element. The castor wheel bar may protrude by a distance greater than the radius of the front wheel. The castor wheel bar may extend forwards at an angle from the third bar element, in front of the front wheel.

A castor wheel may be connected to the castor wheel bar. The castor wheel bar may hold the castor wheel clear of the ground.

In the folded configuration, the castor wheel bar may pivot downwards as the front wheel is raised towards the fourth bar element. This may allow the castor wheel to make contact with the ground below the front wheel.

Preferably two castor wheels are provided, one on the fourth bar element and one on the castor wheel bar, protruding from the third bar element.

A front castor wheel may be connected to the castor wheel bar on the third bar element. A rear castor wheel may be connected to the rear end of the fourth bar element.

By providing two castor wheels at the front and rear of the bicycle, which rotate on an axis perpendicular to the axis of the front and rear wheels, the bicycle may be dragged in the folded configuration in a more stable manner. The folded bicycle may be dragged in a similar manner to a roller suitcase.

In some embodiments, the castors may be swivel castors, in which case the axes of rotation of the castors can move. However, in all cases the castor(s) are able to rotate on axes which are substantially perpendicular to the axes of the front and rear bicycle wheels.

The at least one castor wheel may have a diameter of between 3 to 10 cm.

The third bar element may be attached to the second bar element by at least one gimbal. The third bar element may be attached to the fourth bar element by at least one gimbal. By attaching the third bar element by gimbals, the entire third bar element may be able to rotate along an axis running between the gimbals.

The handlebar may be connected to the third bar element at a top end of the third bar element. The handlebar may allow the bicycle to be steered when ridden in the unfolded configuration by rotating the entire third bar element on the gimbals. This then turns the front wheel and steers the bicycle

At least one carrying handle may be provided. The at least one carrying handle may be connected to the third bar element. The at least one carrying handle may allow the bicycle to be moved in the folded configuration.

The at least one carrying handle may be connected to the top end of the third bar element at the gimbal.

The gimbal may include a gimbal lock. The gimbal lock may be engaged to prevent movement of the handlebars about the steering axis when the bicycle is in the folded configuration.

A seat post may be provided. The seat post may protrude from the fourth bar element.

A bicycle saddle may be provided. The bicycle saddle may be connected to the seat post.

The seat post may protrude from the fourth bar element at a point in front of the bicycle saddle. The seat post may protrude at an angle pointing towards the rear of the bicycle. The bicycle saddle may be connected to the seat post at a point at the front of the bicycle saddle. This provides space underneath the bicycle saddle. The space underneath the bicycle saddle may be occupied by a portion of the frame in the folded configuration.

The bicycle seat may include at least one cut-out and/or at least one aperture. The cross section of the cut-out(s) and/or aperture(s) may be substantially rectangular in shape. The cut-out(s) and/or aperture(s) in the bicycle saddle may allow a portion of the frame to be received inside the bicycle saddle in the folded configuration.

The fourth bar element may include at least one aperture. The cross section of the aperture(s) may be substantially rectangular in shape. The aperture(s) in the fourth bar element may allow a portion of the frame to be received inside the fourth bar element in the folded configuration and/or pass through the fourth bar element when folded.

The bicycle may comprise at least two chains.

At least one chain may be disposed within the first bar element.

The bicycle may comprise at least four sprockets. The crank arms may be connected to a first sprocket. The first sprocket may be rotationally connected to a second sprocket. The second sprocket may be rear of the first sprocket. The first and second sprocket may be rotationally coupled by a first chain.

The second sprocket may be connected to a third sprocket by an axle. The third sprocket may be disposed within the first bar element. The third sprocket may be rotationally coupled to a fourth sprocket. The fourth sprocket may be rear of the third sprocket. The fourth sprocket may be disposed in the first bar element. The third sprocket may be rotationally coupled to the fourth sprocket by a second chain. The second chain may be disposed in the first bar element.

This may allow the first sprocket to be substantially smaller compared to the initial gear of traditional bicycles. The first sprocket may occupy less space in the folded configuration.

One or both of the front and rear axles may be a spigot axle. The spigot axle may comprise a spline.

The spigot axle may pass through the fourth sprocket.

This arrangement allows the crankarms to be rotationally coupled to the rear axle. This arrangement has a narrower width compared to traditional arrangements, allowing the bicycle to have a smaller depth in the folded configuration.

A top portion of the third bar element and a front portion of the fourth bar element may fold away from a plane substantially bisecting the bicycle. The top portion of the third bar element and the front portion of the fourth bar element may be pivotally connected to the frame in an axis perpendicular to the axis of the first, second, third and fourth hinges and/or perpendicular to the steering axis.

### BRIEF DESCRIPTION OF THE DRAWINGS

For a better understanding of the present invention, and to show more clearly how it may be carried into effect, reference will now be made by way of example only to the accompanying drawings, in which:

FIG. 1 shows a side view of a first embodiment of a foldable bicycle in an unfolded configuration according to the present invention;

FIG. 2 shows a perspective view of the foldable bicycle of FIG. 1 in an unfolded configuration;

FIG. 3 shows a front view of the foldable bicycle of FIG. 1.

FIG. 4 shows a side view of the foldable bicycle of FIG. 1 in a folded configuration;

FIG. 5 shows a perspective view of the foldable bicycle of FIG. 1 in a folded configuration; and

FIG. 6 shows a perspective view of a rear wheel of the foldable bicycle of FIG. 1;

FIG. 7 shows a perspective view of a chain disposed within the foldable bicycle of FIG. 1;

FIG. 8 shows a perspective view of the rear wheel of FIG. 6 inserted into a rear sprocket;

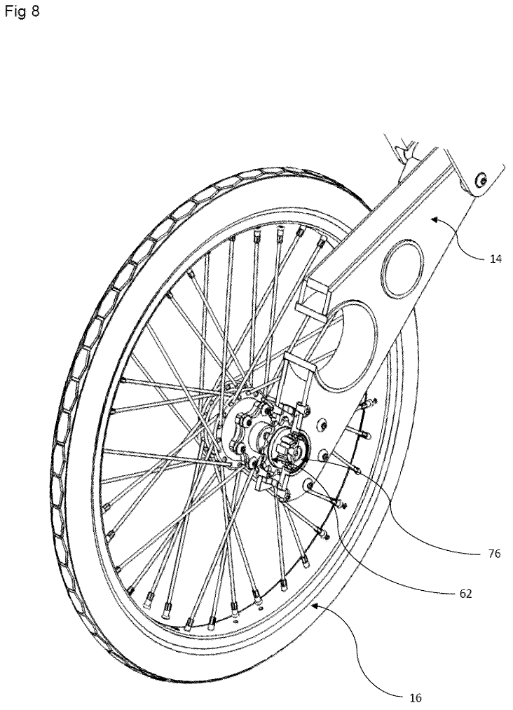

FIG. 9 shows a side view of the foldable bicycle of FIG. 1 in the unfolded configuration, an intermediate configuration and the folded configuration;

FIG. 10 shows a perspective view of a second embodiment of a bicycle according to the present invention;

FIG. 11 shows a perspective view of a third embodiment of a bicycle according to the present invention; and

FIG. 12 shows a side view of the bicycle of FIG. 11 in a folded configuration.

### DESCRIPTION OF PREFERRED EMBODIMENTS

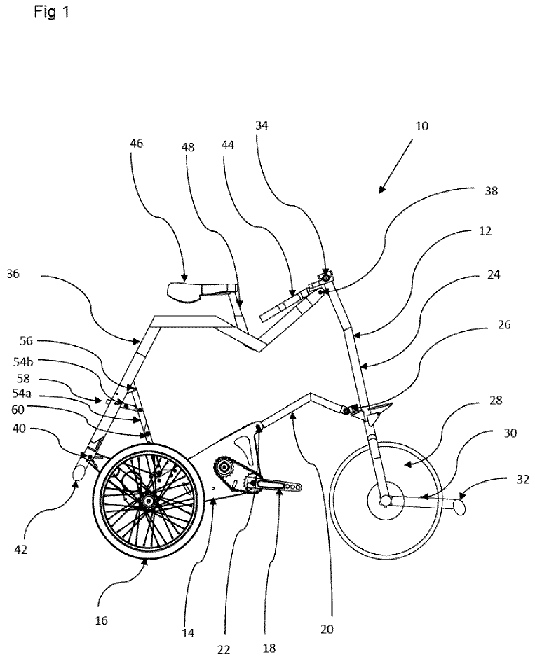

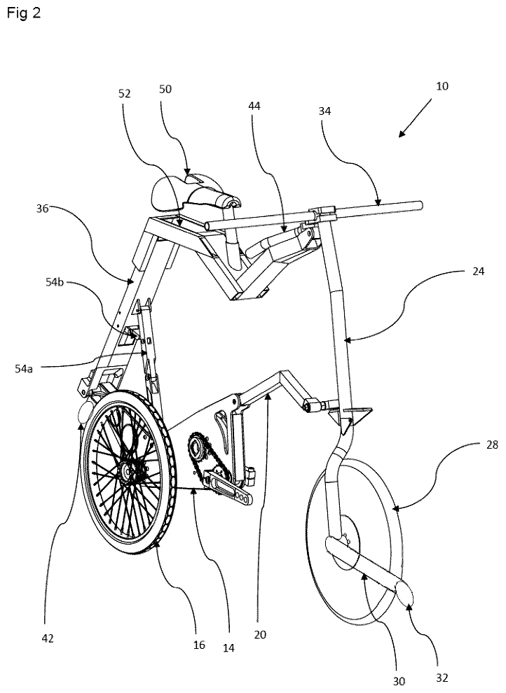

Referring firstly to FIGS. 1 and 2, a foldable bicycle is generally shown at 10. The foldable bicycle has a frame 12. The frame 12 is in the form of a four-bar linkage.

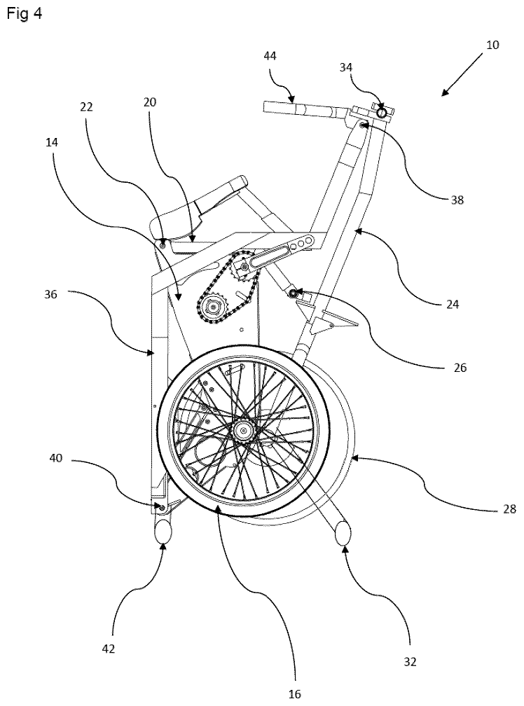

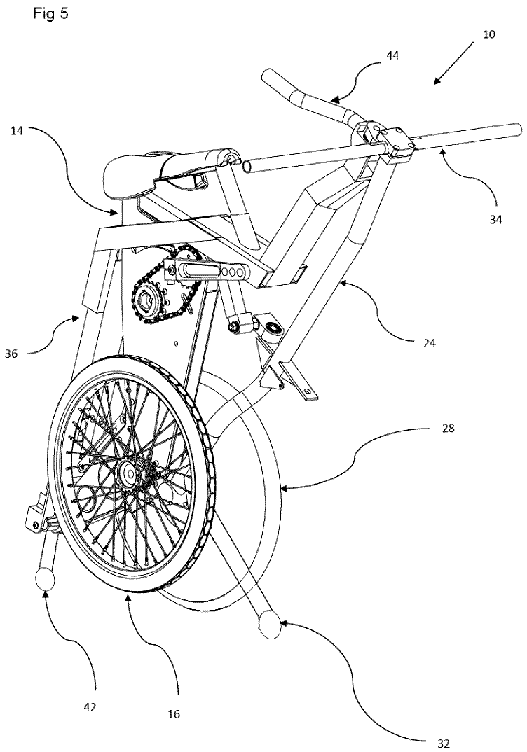

The four-bar linkage allows the frame 12 to be folded from an unfolded configuration (FIGS. 1 to 3) into a folded configuration, shown in FIGS. 4 and 5. This is discussed in more detail below.

The four-bar arrangement includes a first bar element 14, which corresponds to a chain stay portion of the frame and which mounts a rear wheel 16 and pedals/crank arms 18. The first bar element 14 is connected to the second bar element 20 by a first hinge 22. The first hinge 22, when the bicycle is unfolded, is at around a mid-position between the front and rear wheels, just forward of and above the crank arms 18.

The first and second bar elements 14, 20 together form a bottom part of the bicycle frame, when the bicycle is unfolded.

The second bar element 20 is connected to a third bar element 24 by a second hinge 26. The third bar element is approximately vertical when the bicycle is unfolded, and mounts handlebars 34 at the top and the front wheel 28 at the bottom. The second hinge 26 is disposed on the third bar element 24 between the handlebars 34 and the front wheel 28.

A fourth bar element 36 forms a top tube and seat stay portion of the frame. The fourth bar element is connected to the third bar element 24 at a third hinge 38, and to the first bar element 14 at a fourth hinge 40. The fourth hinge 40 is disposed behind the rear wheel 16 when the bicycle is unfolded.

The first, second, third and fourth hinges 22, 26, 38, 40 all rotate about an axis running from one side of a plane substantially bisecting the bicycle 10 and the other side of a plane substantially bisecting the bicycle 10. This axis is parallel with the rear wheel 16 axis. The first, second, third and fourth hinges 22, 26, 38, 40 all pivot about parallel axes.

A rear castor wheel 42 is provided on the fourth bar element 36, particularly on a portion of the fourth bar element 36 which extends beyond the fourth hinge 40 (below the fourth hinge 40 in the unfolded condition shown in FIG. 1). A front castor wheel 32 is provided on a castor wheel bar 30, which is rigidly attached to the third bar element 24 at a position on the third bar element 24 on the axis of the front wheel 28.

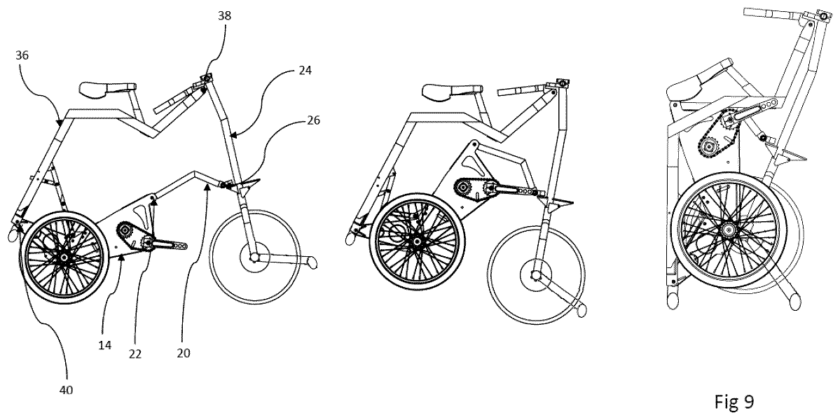

Referring to FIG. 9, it can be seen that as the bicycle is folded, the first hinge 22 rises upwards. The first and second bar elements 14, 20 fold together and the third bar element 24 pivots. This brings the front and rear wheels 16, 28 towards each other and eventually adjacent to each other, side-by-side. At the same time, the wheels 16, 28 move upwards relative to the castor wheels 32, 42. Hence in the folded position, the castor wheels 32, 42 touch the ground and the front and rear wheels 16, 28 do not. The castor wheels 32, 42 can then be used to move the bicycle, in the folded condition, by rolling it in a direction perpendicular to the direction in which it would roll on the front and rear wheels.

### First Bar Element

The first bar element 14 forms a chain stay portion of the frame 12.

The first bar element 14 has a substantially V-shaped profile.

A rear axle is provided. The rear axle protrudes from one side of the first bar element 14. The rear axle is disposed approximately on the point of the “V”, with the arms of the “V” being inclined generally upwardly in front of and behind the rear wheel, when the bicycle is in the unfolded condition. The arm of the “V” which extends in front of the rear wheel widens as it extends away from the point of the “V”.

The rear wheel 16 is disposed on the rear axle. In this embodiment, the rear wheel 16 is smaller than the wheels of traditional bicycles. The rear wheel 16 has a diameter of 40 to 50 cm. It will be appreciated that in other embodiments, the diameter of the rear wheel 16 may be anything suitable for a full-size adult bicycle, for example up to around 75 cm.

The crank arms 18 are disposed protruding from opposite sides of the first bar element 14, forward of the rear axle.

The crank arms 18 are disposed behind and below the first hinge 22. As explained, the forward-extending arm of the “V”-shaped first bar element 14 widens as it extends forwards and away from the point of the “V”, so that there is a significant vertical distance between the top of the forward end of the first bar element 14 and the bottom of the forward end of the first bar element 14. The first hinge 22 is positioned at or near the top of the forward end of the first bar element 14, and the crank arms 18 are positioned at or near the bottom of the forward end of the first bar element 14.

The first bar element 14 mounts a mechanism to enable the pedals, via the crank arms 18, to power the rear wheel 16 and propel the bicycle forwards. This will be explained in more detail below.

A forward end of the first bar element 14 is connected to a rear end of the second bar element 20 by the first hinge 22. The first and second bar elements 14, 20 together form a bottom portion of the bicycle frame, when unfolded, with the first hinge 22 approximately central between the front and rear wheels 28, 16.

### Second Bar Element

The second bar element 20 has a substantially V-shaped profile, i.e. it has two straight sections joined together at an angle to form a point.

The V-shape of the second bar element 20 is inverted relative to the V-shape of the first bar element 14. Whereas the “arms” of the “V” of the first bar element 14 extend upwards from the point, with the “V” pointing downwards, the arms of the “V” of the second bar element 20 incline downwardly from the point, so that the “V” of the second bar element 20 has the point pointing upwards.

The second bar element 20 approximately corresponds to the down tube portion of a traditional bicycle frame 12.

A forward end of the second bar element 20 is connected to the third bar element 24 by a second hinge 26. The forward end of the second bar element 20 is connected to the third bar element 24 at approximately halfway along the length of the third bar element 24, between the handlebars and the front wheel axle.

### Third Bar Element

The third bar element 24 is approximately vertical when the bicycle is unfolded, and forms a steering column for the bicycle. When the handlebars 34 are rotated to steer the bicycle, the whole of the third bar element 24 rotates, to control the front wheel 28 and steer the bicycle.

The steering column is attached to the fourth bar element 36 by a first gimbal. The first gimbal includes the third hinge 26 and a top hinge. The top hinge is pivotally connected to the third hinge 38 of the fourth bar element 36. The top hinge is pivotally connected to the third bar element 24. The top hinge pivots in a direction perpendicular to the direction of the third hinge 26.

The steering column is attached to the second bar element 20 by a second gimbal. The second gimbal includes the second hinge 26 and a bottom hinge. The bottom hinge is pivotally connected to the second hinge 26. The bottom hinge is pivotally connected to the third bar element 24. The bottom hinge pivots in a direction perpendicular to the direction of the second hinge 26.

The top and bottom hinges pivot in the same direction.

The top and bottom hinges allow the third bar element 24 to be rotated along an axis running between the gimbals. This enables the steering column to rotate as the handlebars 34 are rotated.

In this embodiment a top portion of the third bar element 24, between the handlebars 34 and the second hinge 26, is formed from two straight sections at a shallow obtuse angle to each other where they join at a position about a third of the way between the handlebars and the second hinge 26. The angle may be for example around 170 degrees.

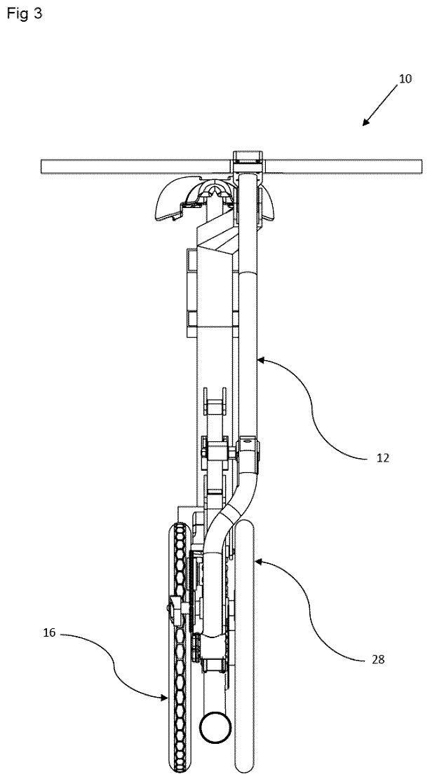

A bottom portion of the third bar element 24, below the second hinge 26, forms essentially a single prong of a traditional bicycle fork. As seen best in FIG. 3, the wheel is mounted to the bottom portion of the third bar element 24, on a front axle to one side of the bottom portion. However, because the third bar element 24 bends out of line, the front wheel remains in line with the steering axis, i.e. the wheel is directly below the pivot point of the handlebars.

In this embodiment, the front wheel 28 is smaller than the wheels of traditional bicycles. The front wheel 28 has a diameter of 40 to 50 cm. It will be appreciated that in other embodiments, the diameter of the rear wheel 16 may be anything suitable for a full-size adult bicycle, for example up to around 75 cm.

The front and rear axles protrude from different sides of a plane substantially bisecting the bicycle 10 into left and right sides.

A castor wheel bar 30 is provided. The castor wheel bar 30 protrudes from the lower end of the third bar element 24 on the opposite side relative to the front axle. The castor wheel bar 30 protrudes from the third bar element 24 at an angle of between 100° and 130°, from the third bar element 24. When the bicycle is unfolded, the castor wheel bar 30 extends forwards, in front of the front wheel 28. This angle ensures the distal end of the castor wheel bar 30 is raised above the ground in the unfolded configuration. As the third bar element pivots from the unfolded configuration to the folded configuration, the front castor bar 30 pivots downwards. The front castor bar 30 extends towards the ground in the folded configuration.

In this embodiment, the castor wheel bar has a length of 45 to 55 cm. This ensures the castor wheel bar 30 has a length greater than the diameter of the front wheel 28.

The distal end of the castor wheel bar 30 from the third bar element 24 is therefore disposed in front of the front wheel 16 in the unfolded configuration.

A front castor wheel 32 is provided. The front castor wheel 32 is connected to the distal end of the castor wheel bar 30. The front castor wheel 32 is raised above the ground in the unfolded configuration and extends towards the ground in the folded configuration. As a result, the front castor wheel 32 is in contact with the ground in the folded configuration.

In this embodiment, the front castor wheel 32 has a diameter of 3 to 10 cm. The diameter of the front castor wheel 32 is preferably 5 to 8 cm. The front castor wheel 32 rotates on a front castor wheel axis, the front castor wheel axis being perpendicular to the front wheel axis, so that the bicycle when folded can be dragged on the castor wheel in a direction substantially in line with the main wheel axes, i.e. in a direction perpendicular to the direction in which the bicycle would be ridden. In some embodiments the castor may be a swivel castor, but in at least one position will be able to rotate on an axis perpendicular to the front wheel axis (and therefore perpendicular also to the rear wheel axis, when the steering column is locked in the folded position).

### Fourth Bar Element

The fourth bar element 36 extends between the top end of the third bar element 24, and the rear end of the first bar element 14. The fourth bar element mounts the saddle, and approximately corresponds with the seat stay and top tube of a traditional bicycle frame.

The fourth bar element 36 is connected to a rear end of the first bar element 14 by a fourth hinge 40. The fourth bar element 36 then extends upwardly, forming the back of the frame 12 (roughly corresponding to the seat stay of a traditional bicycle frame), and then forwards (roughly corresponding to the top tube of a traditional bicycle frame). The fourth bar element 36 is connected to the third bar element 24 at the third hinge 38, at the front and top end of the fourth bar element 36.

The fourth hinge 40 is disposed to the rear of the rear axle. This assists in retracting the rear wheel 16 towards the fourth bar element 36 under its own weight during reconfiguration from the unfolded configuration to the folded configuration.

The fourth bar element 36 extends beyond the fourth hinge 40. In other words, the fourth hinge 40 is not quite at the lower/rear end of the fourth bar element 36, but is for example between about 5 cm to 15 cm from the end. A rear castor wheel 42 is provided. The rear castor wheel 42 is mounted to the rear end of the fourth bar element 36, close to the fourth hinge 40 but beyond the fourth hinge. In this embodiment, the rear castor wheel 42 has a diameter of 5 cm to 8 cm.

The rear castor wheel 42 is mounted so that it can turn on an axis parallel to the axis of the front castor wheel 32. When the bicycle is folded, the first and second castor wheels 32, 42 contact the ground, and the main front and rear wheels 16, 28 are clear of the ground. This allows the bicycle to be dragged on the castor wheels 32, 42.

A carrying handle 44 is provided. The carrying handle 44 is rigidly connected to the top end of the third bar element 36 with respect to the pivot axis of the first, second, third and fourth hinge 22, 26, 38, 40. In other words, the carrying handle 44 does not pivot with respect to the third bar element 36 along an axis parallel to the pivot axis of the first, second, third and fourth hinge 22, 26, 38, 40. During folding, the carrying handle 44 is lifted away from the fourth bar element 36, which pivots the bottom end of the third bar element 24 towards the fourth bar element 36. In other words, the carrying handle 44 may act as a lever to facilitate raising the front wheel 28 during folding. The carrying handle 44 allows the bicycle 10 to be held and maneuvered when in the folded configuration.

In the unfolded configuration, the carrying handle 44 is folded down with its length substantially along the length of the fourth bar element 36.

The carrying handle 44 is pivotally connected to the top end of the third bar element 36 at the first gimbal with respect to the rotational axis of the steering column. As a result, in the unfolded configuration, the steering column may rotate independently of the carrying handle 44.

A gimbal lock may be provided. The gimbal lock is preferably provided on the first gimbal but may be provided on the second gimbal, or on both gimbals. The gimbal lock, when engaged, prevents movement of the steering column, front wheel and handlebars 34 about the steering axis.

The bicycle when folded can be pulled behind a user, using the carrying handle 44 and rolling on the castor wheels, like a roller suitcase.

In the embodiment shown the bicycle has two castor wheels on fixed axes, but in other embodiments the castor wheels could be swivel castors, and/or there may be additional castor wheels, for use like a “spinner” suitcase.

A bicycle saddle 46 is provided. The bicycle saddle 46 is connected to a seat post 48. The seat post 48 protrudes from the fourth bar element 36. In this embodiment, the seat post 48 protrudes from the fourth bar element 36 from a point in front of the front of the bicycle saddle 46. The seat post 48 protrudes at an angle, extending upwards and backwards towards the bicycle saddle 46. The seat post 48 meets the bicycle saddle 46 at the front of a bottom face of the bicycle saddle 46. By positioning the seat post 48 at the front of, or in front of, the bicycle saddle 46, an aperture 52 may be provided through the fourth bar element 36, described in more detail below.

The portion of the fourth bar element 36 extending forwards, roughly corresponding to the top tube of a traditional bicycle fame, features a substantially V-shaped profile, i.e. it has two straight sections joined together at an angle to form a point, in the frame 12 between the bicycle saddle 46 and the handlebars 34. The seat post 48 is disposed to the rear of the point of the “V”, with the arms of the “V” being inclined generally upwardly in front of and behind the seat post 48, when the bicycle 10 is in the unfolded configuration. The arm of the “V” which extends in front of the seat post 48 extends towards the gimbal.

The V-shaped profile between the seat post 48 and the handlebars 34 allows the seat post 48 to be longer while still connecting to the bicycle saddle approximately in line with the handlebars 34. By having a seat post 48 with a greater length, the seat post 48 can be formed from a first hollow tube disposed above a second hollow tube with the first tube telescopically inserted into the second tube. This allows the height of the seat post 48 to be adjustable.

The bicycle saddle 46 is substantially parallel to the ground when in the unfolded configuration.

The bicycle saddle 46 includes a cut-out 50. The cross section of the cut-out 50 is substantially rectangular in shape. The cut-out 50 extends from the rear of the bicycle saddle 46 towards the front of the bicycle saddle 46. The cut-out 50 extends by 5 to 10 cm from the rear of the bicycle saddle 46.

The cut-out 50 in the bicycle saddle 46 allows a portion of the frame 12 to be received inside the bicycle saddle 46 in the folded configuration as described below.

The bar elements 14, 20, 24, 36 are box sections with a top wall, a bottom wall, a left wall and a right wall. The fourth bar element 36 has an aperture 52. The aperture 50 runs through a portion of the fourth bar element 36 forming the top bar. The cross section of the aperture 52 is substantially rectangular in shape. The aperture 52 passes through the bottom wall through to the top wall. In other words, as a result of the aperture 52, a top bar portion of the fourth bar element 36 consists of two opposing plates (the left wall and the right wall). The aperture 52 is disposed substantially below the cut-out 50 in the bicycle saddle 46.

The aperture 52 in the fourth bar element 36 allows a portion of the frame 12 to be received inside the fourth bar element 36 in the folded configuration as described below.

In the unfolded configuration, the front and rear castor wheels 32, 42 are clear of the ground the bicycle 10 is situated on. This prevents the front and rear castor wheels 32, 42 from making contact with the ground as the bicycle 10 is ridden in the unfolded configuration.

In the unfolded configuration the front and rear wheels 28, 16 are in contact with the ground. This allows the bicycle 10 to move according to the rotation of the front and rear wheels 28, 16 when in the unfolded configuration.

Referring to FIG. 3, the front and rear wheels 28, 16 are disposed either side of a plane substantially bisecting the frame 12. The result of this arrangement is a narrower depth in the folded configuration. This arrangement also allows tyres on the front and rear wheel 28, 16 to be changed without removing the front or rear wheel 28, 16 from the front or rear axle.

### Folded Configuration

Now referring to FIGS. 4 and 5, the foldable bicycle 10 is shown in a folded configuration.

In the folded configuration, the front end of the first bar element 14 is raised. The rear end of the second bar element 20 is raised. The bottom end of the third bar element 24 is brought closer to the rear end of the fourth bar element 36.

In the folded configuration a portion of the first and second bar elements 14, 20 pass through the aperture 52 in the fourth bar element 36. The portion of the first and second bar elements 14, 20 which pass through the aperture 52 in the fourth bar element 36 in the folded configuration includes the first hinge 22.

In the folded configuration, the front wheel 28 is raised as the bottom end of the third bar element 24 pivots upwards. As a result, the front castor wheel 32 is lowered towards the ground.

In the folded configuration, the rear end of the fourth bar element 36 is lowered. As a result, the rear castor wheel 32 is lowered towards the ground.

Reconfiguration from the unfolded configuration to the folded configuration results in the front and rear wheels 28, 16 being raised while the front and rear castor wheels 32, 42 are lowered. In the folded configuration, the front and rear wheels 28, 16 are clear of the ground. In the folded configuration the front and rear castor wheels 32, 42 are in contact with the ground.

This allows the bicycle 10 in the folded configuration to be dragged or pushed on its front and rear castor wheels 32, 42 rather than on its front and rear wheels 28, 16. The bicycle can be dragged behind a person, like a roller suitcase. This is very convenient and stable. Note that it is very difficult for a person to pull a bicycle behind them if it is to be pulled on its normal road wheels, or on any wheels when it is being pulled in the same direction that it would be ridden. This is because a bicycle is inherently unstable and will tend to fall to one side or the other unless it is being ridden at sufficient speed. By dragging the bicycle behind in the direction perpendicular to the direction it would normally be ridden, it is supported in the side-to-side direction in which it would tend to fall, and is in any case stable in the other direction (a stationary bicycle would not fall forwards or backwards, simply because of the way the mass is distributed over the points of contact with the ground).

In the folded configuration, the front and rear wheels 28, 16 are disposed adjacent to each other, side-by-side.

The carrying handle 44 may be raised in the folded configuration for pulling the folded bicycle 10 on the front and rear castor wheels 32, 42 in a perpendicular direction from planes substantially bisecting the front and rear wheels 28, 16. This also locks the steering mechanism, preventing any rotation of the third bar element 24 on the steering axis.

In other embodiments, each side of the handlebar 34 may be retractable, or the handlebar may be removable, foldable or rotatable to make for a more convenient overall folding position. When each side of the handlebar 34 is foldable towards the frame 12, they may be disposed along the third bar element 24. A cam disposed at the first gimbal may lock the handlebars 34 in an unfolded position when the bicycle 10 is in the unfolded configuration. The cam may lock the handlebars 34 in a folded position when the bicycle 10 is in the folded configuration.

In other embodiments, the handlebars 34 may automatically fold to their folded position when the bicycle 10 is folded. The handlebars 34 may automatically unfold to their unfolded position when the bicycle 10 is unfolded. The automatic folding and unfolding of the handlebars 34 may be performed by a mechanical biasing mechanism disposed in the first gimbal.

In some embodiments, the biasing mechanism may include a spring. The mechanical biasing mechanism may retain the handlebars in the folded or unfolded position when the bicycle 10 is in the folded or unfolded configuration and release the handlebars allowing them to unfold/fold to the other position when the bicycle 10 is in the other configuration.

The handlebars 34 may have a mechanical linkage between the third bar element 24 which allows the handlebars 34 to move from their folded and unfolded position as the third bar element 24 is moved from the folded configuration position and unfolded configuration position.

### Locking Mechanism

The frame 12 is provided with a locking mechanism, shown most clearly in FIGS. 1 and 2. The locking mechanism in this embodiment is a dyad locking mechanism. The dyad locking mechanism locks by means of an over-centre lever. The dyad locking mechanism can be configured between a locked position and an unlocked position.

The dyad locking mechanism has a first dyad portion 54a and a second dyad portion 54b.

The first dyad portion 54a has a bottom end connected to the first bar element 14. The first dyad portion 54a is connected to the first bar element 14 at the centre of the V-shape of the first bar element 14, i.e. about at the point of the “V”. The first dyad portion 54a is connected to the first bar element 14 by a hinge.

The first dyad portion 54a has a top end pivotally connected to the fourth bar element 36 by a hinge 56.

The first dyad portion has a hinge 60. The hinge 60 is disposed approximately in the centre of the first dyad portion 54a.

The hinge 60 divides the first dyad portion 54a into a first half and a second half. As the foldable bicycle is reconfigured from the unfolded configuration to the folded configuration, a first half of the first dyad 54a comprising the bottom end folds towards the first bar element 14 and a second half of the first dyad portion 54b comprising the top end folds towards the fourth bar element 36.

The dyad locking mechanism has a second dyad portion 54b. The purpose of the second dyad portion is to lock the first dyad portion in the unfolded configuration. In turn, the second dyad portion locks itself because the second dyad portion moves past a centre point so that it will not fold without being deliberately pushed back over the centre.

The second dyad portion 54b is pivotally connected to the first dyad portion 54a by a hinge. The second dyad portion 54b is connected to the first dyad portion 54a at approximately a quarter of the length of the first dyad portion 54a from its top end.

The second dyad portion 54b is pivotally connected to the fourth bar element 36 at approximately a quarter of its length from the rear end of the second dyad portion 54b. In this embodiment, the second dyad portion 54b is connected to the fourth bar element 36 at approximately half-way along the length of the seat stay portion of the fourth bar element 36.

The second dyad portion 54b has an extension 58 at the rear end of the second dyad portion 54b. The extension of the second dyad portion 54b, past the fourth bar element, provides an operating handle 58 for unlocking the dyad and folding the bicycle. The operating handle 58 protrudes from behind the fourth bar element 36 when the bicycle is unfolded. The operating handle 58 allows the over-centre second dyad portion to be “unlocked” and folded by lifting the operating handle 58, i.e. the rear end of the second dyad portion 54b.

By positioning the operating handle 58 at the fourth bar element 36, the risk that the handle 58 is accidentally lifted by movement of the operator's body whilst the bicycle 10 is being ridden in the unfolded configuration is mitigated.

In the locked position, the first dyad portion 54a is held in a straight orientation with a tension load on the second dyad portion 54b.

This locking mechanism locks the first bar element 14 and fourth bar element 36 in place, relative to each other in the unfolded configuration. This provides a rigid structure in the unfolded configuration.

### Rear Wheel Arrangement

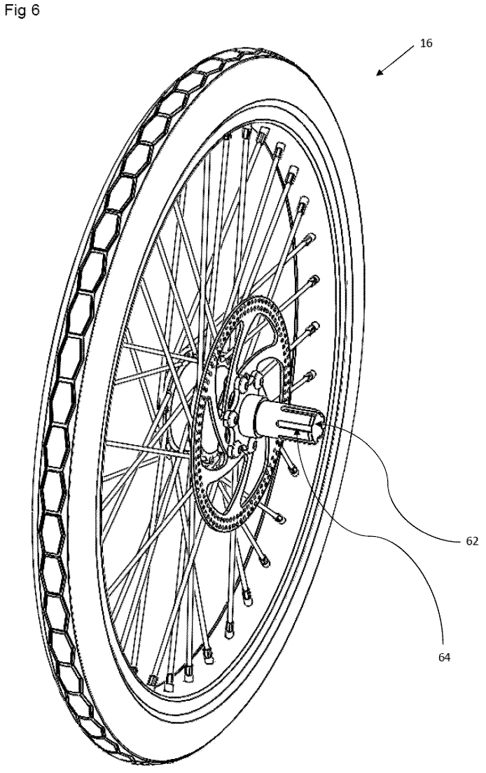

In FIG. 6, a rear wheel is generally shown at 16.

The rear axle protrudes from the rear wheel 16. The rear axle has a distal end from the rear wheel 16. The rear axle provides a spigot 62. The spigot 62 is disposed on the distal end of the rear axle.

The spigot 62 has a spline 64 protruding from the distal end of the rear axle towards the rear wheel 16. The spline 64 extends by approximately two thirds of the length of the spigot 62

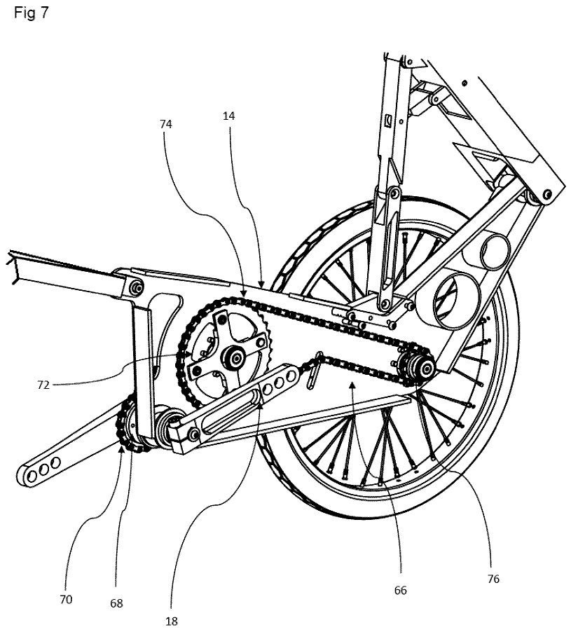

Referring to FIG. 7, the first bar element 14 has a hollow housing 66. The hollow housing 66 comprises two cover plates and walls connecting the two cover plates together substantially along each side of each cover plate. In FIG. 7, one cover plate has been removed to show the internal components of the first bar element 14.

The crank arms 18 are attached through the first bar element housing 66. The crank arms 18 are rotationally coupled to a first sprocket 68. A first chain 70 is mounted on the first sprocket 68.

The first chain 70 is mounted on a second sprocket to the rear of the first sprocket 68.

The second sprocket has a radius and the first sprocket 68 has a radius and the radius of the first sprocket 68 and second sprocket are substantially similar. In other embodiments the radius of the second sprocket may be slightly smaller than the radius of the first sprocket 68. This enables the first sprocket 68 and second sprocket to have a gear ratio of approximately 1:1.

The second sprocket is rotationally coupled to a third sprocket 72. The second sprocket and third sprocket 72 are connected by a layshaft. The third sprocket 72 is disposed inside the first bar element housing 66.

The third sprocket 72 has a radius substantially greater than the radius of the second sprocket. The third sprocket 72 has a greater number of teeth than the second sprocket.

A second chain 74 is disposed in the first bar element housing 66, mounted to the third sprocket 72.

The second chain 74 is mounted to a fourth sprocket 76 disposed to the rear of the third sprocket 72. The fourth sprocket 76 is disposed inside the first bar element housing 66.

The fourth sprocket 76 has a radius substantially smaller than the radius of the third sprocket 72.

The fourth sprocket 76 is substantially smaller than the third sprocket 72, having fewer teeth. The result is an increase in speed of the fourth sprocket and a reduction in torque.

It will be appreciated that the embodiment shown in the drawings has a single fixed-ratio gear. However, selectable gears may be provided in embodiments, for example by providing a derailleur mechanism and multiple sprockets in place of the fourth sprocket 76.

FIG. 7 shows the rear wheel 16 inserted into the fourth sprocket 76.

The distal end of the spigot 62 is inserted into a corresponding socket rotationally coupled with the fourth sprocket 76. This allows the rear wheel 16 to be rotationally coupled to the fourth sprocket 76.

This arrangement allows the crank arms 18 and rear wheel 16 to be rotationally coupled through the chains 70, 74 and sprockets 68, 72, 76.

The two-chain arrangement allows the first sprocket 68 to have a shorter radius compared to the initial gear of traditional bicycles, which would otherwise prove difficult to store in the folded configuration. A larger sprocket is instead disposed on a layshaft in the first bar element housing 66 behind the crank arms. Note that the larger sprocket can be located at a point higher up on the bicycle than the pedals, which enables a more compact folded arrangement.

By housing the second chain 74 and third and fourth sprockets 72, 76 inside the first bar element housing 66, the overall width of the bicycle 10 required to contain the necessary parts is reduced, and thereby reduces the depth of the bicycle 10 in the folded configuration.

The embodiments described above are provided by way of example only, and various changes and modifications will be apparent to persons skilled in the art without departing from the scope of the present invention as defined by the appended claims.

### Second Folded Configuration

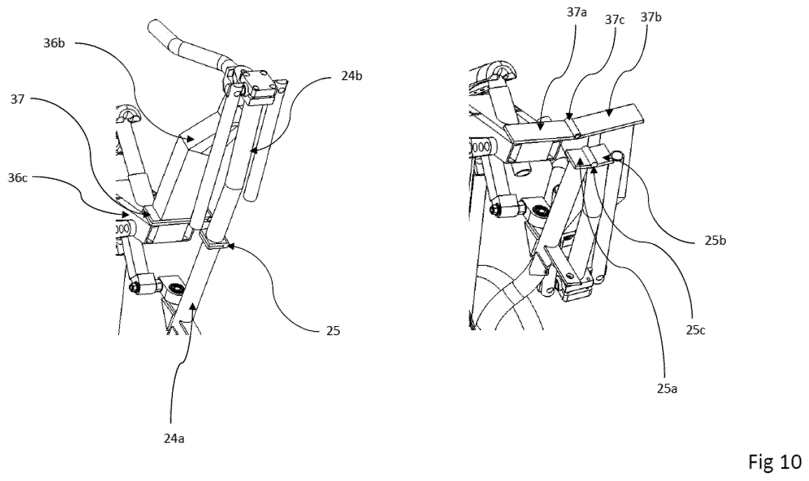

FIG. 10 shows a second embodiment. The second embodiment contains the features of the first embodiment.

In the second embodiment, the fourth bar element 36 is divided into a first portion 36a and a second portion 36b, to facilitate a second stage fold to make the bicycle more compact, for example for storage in a luggage rack. The fourth bar element 36 is otherwise the same as the single, rigid, fourth bar element of the first embodiment The first portion 36a and second portion 36b meet at the point of the “V” of the V-shaped portion of the fourth bar element 36. The second portion 36b pivots relative to the first portion 36a on a hinge 37. The hinge 37 is in the form of two hinge plates 37a, 37b and a pivot 37c in the form of a pin and knuckle.

The third bar element 24 is divided into a first portion 24a and a second portion 24b. The first portion 24a and second portion 24b meet at a point approximately a third of the length of the third bar element 24 from the handlebars 34. The second portion 24b pivots relative to the first portion 34a on a hinge 25. The hinge 25 includes two hinge plates 25a, 25b, and a pivot 25c in the form of a pin and knuckle.

The hinges 25, 37 share a pivot axis. The hinges 37 and 25 allow the foldable portions of the third and fourth bar elements 24b, 36b to fold downwards and towards the left side of the bicycle. The pivot axis of the hinges 35, 37 is substantially perpendicular to the axis of the first, second, third and fourth hinges 22, 36, 38, 40 which connect the bar elements of the frame 12.

A locking device is preferably provided to lock hinges 25, 37 in the unfolded position. The hinges will need to be locked when the bicycle is unfolded for riding, but may also be locked to fold the bicycle into the position shown in FIGS. 4 and 5, for dragging the folded bicycle like a roller suitcase. The second stage fold of the second embodiment gives a further option for compact storage, for example in a luggage rack.

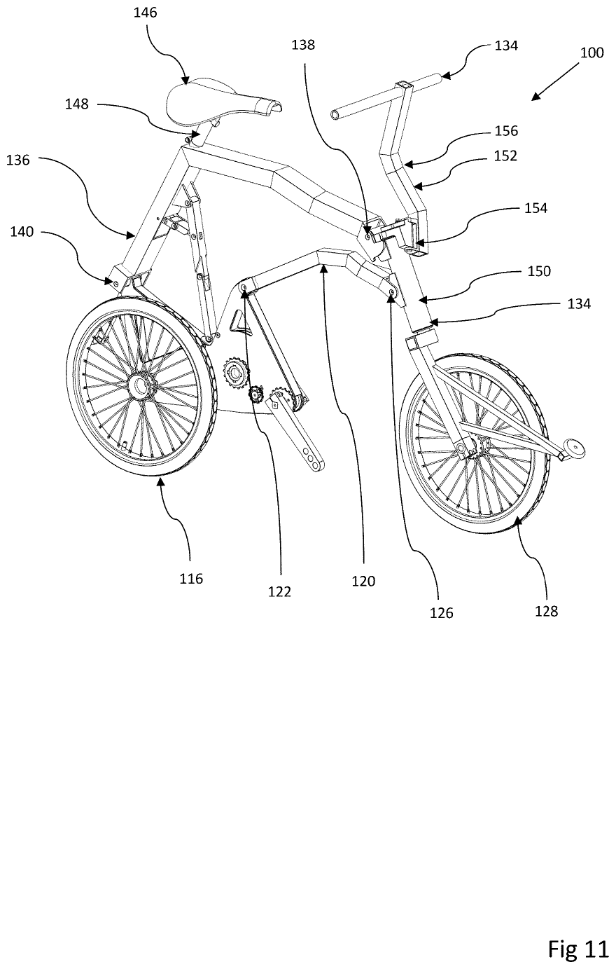

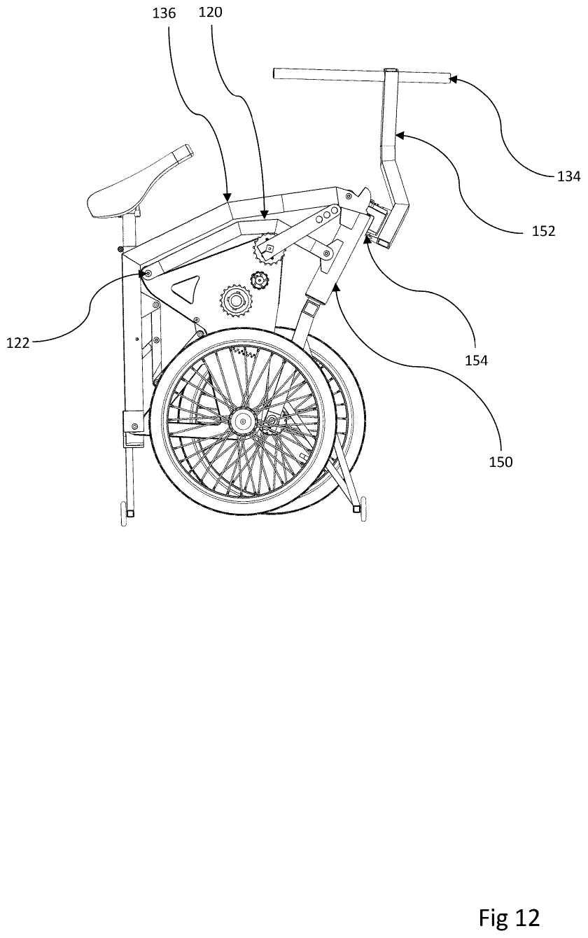

Referring to FIGS. 11 and 12, a third embodiment of the foldable bicycle is generally indicated at 100. The bicycle is shown in an unfolded configuration in FIG. 11 and a folded configuration in FIG. 12. The features of the foldable bicycle 100 are substantially similar to the bicycle 10 of first embodiment. Differences between the bicycles of the first and third embodiments are discussed below.

In this embodiment, the third bar element 124 includes a headtube 150 and a handlebar extension 152. The handlebar extension 152 is connected to the headtube 150 by a handlebar hinge 154.

The handlebar extension 152 includes a handlebar stem 156. The handlebar extension 152 includes handlebars 134. The handlebars 134 protrude from the handlebar stem 156. In this embodiment, the handlebars 134 each have a different length.

The handlebar stem 156 is connected to the handlebar hinge 154. The handlebar hinge 154 allows the handlebar stem 156 to be rotated relative to the headtube 150, as shown in FIG. 12. In this embodiment, the handlebar hinge 154 has an axis which extends in the direction roughly parallel to the headtube 150. Rotating the handlebar stem 156 moves the handlebars 134 so that they may extend in a direction parallel to the wheels 116, 128 (i.e. parallel to front-to-back extent of the bicycle when folded). In other words, the bicycle 100 may fold to a more compact, flat, shape for storage. Additionally, in this embodiment, the handlebars 134 may be used in place of the carry handle 44.

In this embodiment, the gimbals are not present. The headtube 150, which forms the third bar element of the four-bar-linkage, allows the handlebars 134 to steer the bicycle 100 via a steering column which passes through the headtube 150.

The second hinge 126 is connected to the headtube 150. The third hinge 138 is connected to the headtube 150. In this embodiment, the second hinge 126 and third hinge 138 are disposed closer together than those of the first embodiment.

The fourth hinge 140, and hence the bottom of the fourth bar member 136, is disposed higher up relative to the rear wheel, compared with the first embodiment.

FIG. 12 shows the bicycle 100 in the folded configuration. In this embodiment, the second bar element 120 is disposed adjacent to the fourth bar element 136. In other words, the first hinge 122 does not pass through the fourth bar element 136 in the folded configuration.

What is claimed is:

1. A bicycle comprising:
a frame comprising;
a first bar element;
a second bar element;
a third bar element;
a fourth bar element; and
wherein the first bar element is pivotally connected to the second bar element by a first hinge, the second bar element is pivotally connected to the third bar element by a second hinge, the third bar element is pivotally connected to the fourth bar element by a third hinge and the fourth bar element is pivotally connected to the first bar element by a fourth hinge;
a front axle protruding from the third bar element for mounting a front wheel;
a rear axle protruding from the first bar element for mounting a rear wheel, wherein the fourth hinge is disposed rear of the rear axle;
at least one handlebar attached to the third bar element;
at least one crank arm for mounting pedals, disposed on the first bar element;
in which the foldable bicycle is configurable between a folded and unfolded configuration, wherein the first hinge is raisable towards the fourth bar element, bringing the front and rear wheel substantially side-by-side in the folded configuration.

2. (canceled)

3. The bicycle as claimed in claim 1, in which at least one castor wheel is provided, protruding from at least one bar element, the castor wheel being rotatable on a castor wheel axis which is perpendicular to the front and rear wheel axes;

4. The bicycle as claimed in claim 3, in which, in the folded configuration, the front and rear wheels are moved upwards relative to the at least one castor wheel when the front and rear wheel are brought together.

5. The bicycle as claimed in claim 3, in which two castor wheels are provided.

6. The bicycle as claimed in claim 3, in which at least one castor wheel is connected to the third bar element.

7. The bicycle as claimed in claim 3, in which the at least one castor wheel is connected to the fourth bar element.

8. The bicycle as claimed in claim 7, in which a rear end of the fourth bar element protrudes past the fourth hinge by 5 to 10 cm and a castor wheel is mounted to an end of the protrusion.

9. The bicycle as claimed in claim 3, in which a castor wheel bar for mounting a castor wheel protrudes from at least one bar element.

10. The bicycle as claimed in claim 9, in which the castor wheel bar protrudes from the third bar element.

11. The bicycle as claimed in claim 10, in which the castor wheel bar protrudes forwards from a bottom end of the third bar element, in which an angle between the front castor bar and the third bar element is between 100° and 130°.

12. The bicycle as claimed in claim 1, in which the bicycle comprises at least one locking mechanism for locking the bicycle in the unfolded configuration.

13. (canceled)

14. The bicycle as claimed in claim 1, in which the front and/or rear axle are fixed to the frame at only one end.

15. The bicycle as claimed in claim 14, in which the rear axle protrudes from one side of the frame and the front axle protrudes from the other side of the frame.

16. The bicycle as claimed in claim 1, in which the third bar element is attached to the fourth bar element by a first gimble.

17. The bicycle as claimed in claim 16, in which the first gimble features a gimbal lock.

18. The bicycle as claimed in claim 1, in which the third bar element is attached to the second bar element by a second gimble.

19. The bicycle as claimed in claim 1, in which a carrying handle is provided.

20. (canceled)

21. (canceled)

22. The bicycle as claimed in claim 1, in which the bicycle comprises at least two chains.

23. (canceled)

24. The bicycle as claimed in claim 1, in which at least one of the bar elements comprises an aperture for receiving a portion of the frame in the folded configuration.

25. The bicycle as claimed in claim 1, in which at least one bar element comprises a substantially V-shaped profile.
